(19) United States
(12) Patent Application Publication
(10) Pub. No.: US 2009/0174715 A1
(43) Pub. Date: Jul. 9, 2009

(54) DISPLAY PROCESSING DEVICE, DISPLAY PROCESSING METHOD, AND DISPLAY PROCESSING PROGRAM

(75) Inventors: Hajime Adachi, Saitama (JP); Reiji Matsumoto, Saitama (JP); Kazuo Murata, Saitama (JP); Yuya Kawagishi, Saitama (JP)

Correspondence Address: YOUNG & THOMPSON, 209 Madison Street, Suite 500, ALEXANDRIA, VA, 22314, US

(73) Assignee: PIIONEER CORPORATION, TOKYO (JP)

(21) Appl. No.: 12/295,385

(22) PCT Filed: Mar. 12, 2007
(86) PCT No.: PCT/JP2007/054859

§ 371 Date: Oct. 9, 2008

(30) Foreign Application Priority Data
Mar. 31, 2006 (JP) 2006-099054

(51) Int. Cl. G06T 11/00

(52) U.S. Cl. 345/467

(57) ABSTRACT

A font controller extracts and reads each time only the pre-rasterized bitmap font data groups to be used simultaneously among a plurality of pre-rasterized bitmap font data groups stored on the hard disk drive in advance, and expands and stores the groups in a work memory. With this arrangement, it is possible to significantly decrease the amount of memory consumed because the memory capacity required in the work memory is sufficient only with the read data amount to be extracted.

### CROSS-REFERENCE TO RELATED APPLICATION

This application is based on Japanese Patent Application No. 2006-099054 filed on Mar. 31, 2006, the contents of which is incorporated hereinto by reference.

### BACKGROUND OF THE INVENTION

1. Field of the Invention

The present invention relates to a display processing apparatus, display processing method, and display processing program used in a navigation apparatus, etc.

2. Description of the Related Art

In a navigation apparatus, for example, the characters of geographical names, etc., included on a map screen, and the character strings of options and other descriptions included on a menu screen, etc., are drawn using font data provided within the apparatus. Particularly, in the recent navigation apparatus, there is a tendency to use high-definition display apparatus, and there is a demand for enhanced character expressiveness as well as the capability of using characters of various sizes. In accordance with such a demand, scalable fonts are used. These scalable fonts express the locus of a character using vectors, making it possible to display the character in any character size. Yet, when characters are drawn using scalable fonts, it is necessary to execute expansion processing and create data of a bitmap format, resulting in a larger processing load than that in a case where various character strings are displayed using bitmap fonts originally configured by bitmap format data and, as a result, the inconvenience of a long drawing time.

Here, apparatus that address such an inconvenience have been known in the past. For example, in JP, A, 2005-009936, there is disclosed a navigation apparatus wherein a font data group comprising pre-rasterized bitmap data (bitmap font data) in which scalable fonts have been expanded into preferred sizes in advance for characters having a high frequency of use are stored in a data group storage means (font memory). In this navigation apparatus, when the pre-rasterized bitmap data corresponding to specified character codes are stored in the data group storage means, the pre-rasterized bitmap data are read; and when the pre-rasterized bitmap data are not stored in the data group storage means, the scalable font data corresponding to the character codes are read and expanded into bitmap data. (Refer to JP, A, 2005-009936, for example.)

In the above-described conventional technology, the pre-rasterized bitmap data stored in advance in the data group storage means for characters having a high frequency of use are read and displayed so as to reduce the occasions in which scalable font data, which require a long processing time, are used, making it possible to reduce the time required for character display.

Here, generally, when characters are displayed on a navigation apparatus, the font data are displayed on the display apparatus by reading the font data group stored in the data group storage means and temporarily storing the data group in a temporary storage means such as work memory. That is, in the above-described conventional technology, all pre-rasterized bitmap data stored in advance in the data group storage means are temporarily stored in the temporary storage means and then the characters are displayed. At this time, in the above-described conventional technology, although data limited to the characters having a high frequency of use are stored in the data group storage means, characters of a variety of sizes are used with the display apparatus of the navigation apparatus, etc., according to the display range and display magnification rate, resulting in the need to store bitmap data of a variety of sizes for each character. As a result, the size of the data stored becomes relatively large, and the amount of memory consumption of the temporary storage means in which all of these data are temporarily stored also increases.

Thus, in the above-described conventional technology, a reduction in the amount of memory consumption of the temporary storage means was not taken into consideration.

The above-described problem is given as one example the present invention should solve.

### SUMMARY OF THE INVENTION

To overcome the problem, the present invention according to claim 1 is a display processing apparatus that creates and outputs display data for displaying a character or visual object (symbols, signs, etc.) on a display device, comprising: a temporary storage means that temporarily stores display data in a readable/writable manner; and a first pre-rasterized data reading processing means that extracts and reads a first font data group, which satisfies a predetermined first condition in relation to the display relevance of the display means, among a plurality of font data groups stored in a data group storage means and respectively comprising a plurality of pre-rasterized bitmap data related to a character or visual object, and stores the read first font data group in a pre-rasterized data area of the temporary storage means.

To overcome the problem, the present invention according to claim 8 is a display processing method for creating and outputting display data for displaying a character or visual object on a display device, wherein: among a plurality of font data groups stored in a data group storage means and respectively comprising a plurality of pre-rasterized bitmap data related to a character or visual object, a first font data group that satisfies a predetermined first condition in relation to the display relevance of the display means is extracted and read from the data group storage means, and stored in a pre-rasterized data area of a temporary storage means.

To overcome the problem, the present invention according to claim 13 is a display processing program that executes in an operation means provided in a display processing apparatus a procedure wherein: among a plurality of font data groups stored in a data group storage means and respectively comprising a plurality of pre-rasterized bitmap data related to a character or visual object, a first font data group that satisfies a predetermined first condition in relation to the display relevance of a display device is extracted, read, and stored in a pre-rasterized data area of a temporary storage means.

### BRIEF DESCRIPTION OF THE DRAWINGS

FIG. 1 is a block diagram showing the overall functional configuration of a vehicle navigation apparatus comprising a display processing apparatus of an embodiment of the present invention.

FIG. 2 is a functional block diagram showing the main part of the functional configuration of the display processing apparatus of an embodiment of the present invention.

FIG. 3 is a flowchart showing a control procedure executed by the font controller.

### DETAILED DESCRIPTION OF THE PREFERRED EMBODIMENTS

The following describes an embodiment of the present invention with reference to accompanying drawings.

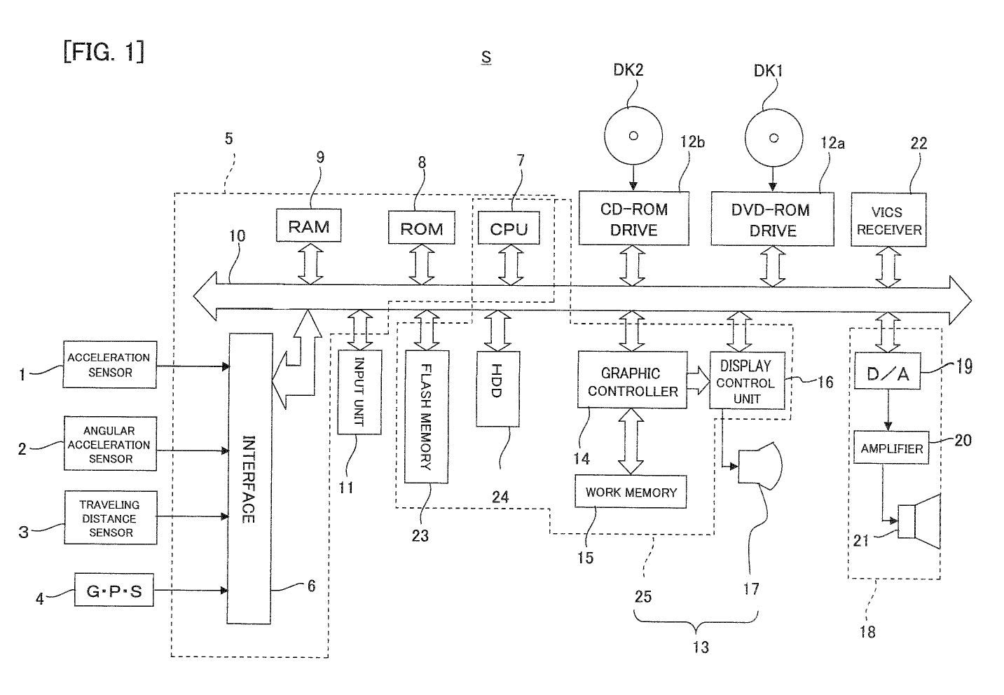

FIG. 1 is a block diagram showing the overall functional configuration of a vehicle navigation apparatus comprising a display processing apparatus of the embodiment.

As shown in FIG. 1, a vehicle navigation apparatus S comprises an acceleration sensor 1 that detects the actual acceleration applied in the advancing direction of the vehicle when the vehicle starts or stops moving or accelerates or decelerates, and outputs the acceleration data; an angular acceleration sensor 2 that detects an angular acceleration of rotation of the vehicle so as to output angular acceleration data and relative orientation data; a traveling distance sensor 3 that detects a vehicle speed pulse signal corresponding to the rotation of the wheels; and a GPS (Global Positioning System) receiver 4 that receives radio waves from GPS satellites so as to output GPS position measuring data, such as the latitude and longitude of the position of the vehicle, and absolute orientation data indicating the advancing direction of the vehicle. Here, examples of the acceleration sensor 1 include many forms, such as a capacitance type or piezo-type semiconductor acceleration sensor, a piezoelectric-type accelerator sensor, and the like.

The navigation apparatus S further comprises a system controller 5 that controls the whole navigation apparatus based on the acceleration data, the relative orientation data, the angular acceleration data, the traveling distance data, the GPS position measuring data, and the absolute position data respectively outputted from the accelerator sensor 1, the angular acceleration sensor 2, the traveling distance sensor 3, and the GPS receiver 4; an input unit 11 such as a key operation panel or remote controller for inputting various data; a hard disk drive 24, a flash memory 23, a DVD-ROM (DVD Read Only Memory) drive 12a, and a CD-ROM (Compact Disk Read Only Memory) drive 12b that read and output various data such as map data including road data representing a number of traffic lanes, road widths, and the like, and data representing names of facilities and detailed information from at least one of the hard disk drive 24, the flash memory 23, a DVD-ROM disk DK1, and/or a CD-ROM disk DK2 under the control of the system controller 5; a display unit 13 that displays the various display data under the control of the system controller 5; an audio player 18 that plays and outputs various sound data under the control of the system controller 5; and a VICS (Vehicle Information and Communication System) receiver 22 that receives traffic information based on a VICS.

The system controller 5 comprises an interface 6 that performs an interface operation with the external sensors such as the GPS receiver 4; a CPU 7 that calculates the traveling distance of the vehicle by measuring the number of pulses of the vehicle speed pulse signal from the traveling distance sensor 3, and controls the whole system controller 5; a ROM (Read Only Memory) that stores a control program and the like for controlling the system controller 5; and a readable/writable RAM (Random Access Memory) 9 that stores various data such as the route data set in advance by a user via the input unit 11. The system controller 5 is connected with the input unit 11, the hard disk drive 24, the flash memory 23, the DVD-ROM drive 12a, the CD-ROM drive 12b, the display unit 13, the audio player 18, and the VICS receiver 22 via a bus line 10.

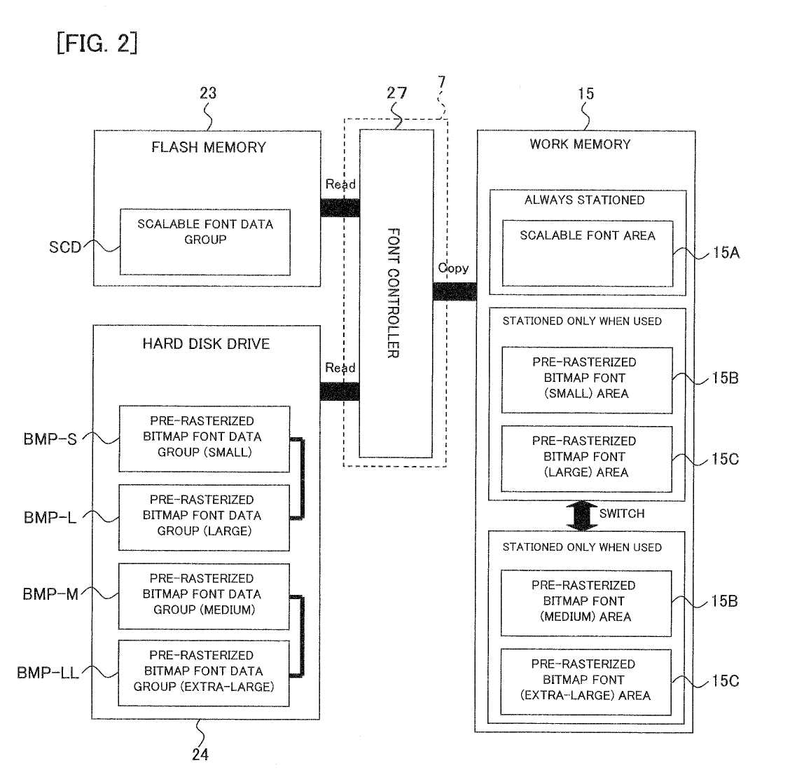

The display unit 13 includes a display 17, such as an LCD unit or CRT display apparatus, and a display processing apparatus 25 that creates and outputs display data for displaying a character or visual object on the display 17. The display processing apparatus 25 comprises the CPU 7; a graphic controller 14 that controls the whole display unit 13 based on control data transmitted from the CPU 7 via the bus line 10; a work memory 15 that is composed of a memory such as VRAM (Video RAM) and that temporarily stores the image information of characters, visual objects, or the like in a readable/writable manner; a display control unit 16 that controls the display 17 based on the image data outputted from the graphic controller 14; the flash memory 23 that stores a scalable font data group (refer to FIG. 2 described later) comprising a plurality of scalable font data related to a character or visual object; and the hard disk drive 24 that comprises a hard disk (not shown) that stores a plurality of font data groups respectively comprising a plurality of pre-rasterized bitmap data related to a character or visual object.

The audio player 18 comprises a D/A converter 19 that converts digital sound data transmitted via the bus line 10 from the nard disk drive 24, the flash memory 23, the DVD-ROM drive 12a, the CD-ROM drive 12b, and/or the RAM 9 into an analog sound signal; an amplifier 20 that amplifies the analog sound signal outputted from the D/A converter 19; and a speaker 21 that converts the amplified analog sound signal into a sound so as to be outputted.

FIG. 2 is a conceptual functional block diagram showing the font control function, which is one of the functions of the above-described display processing apparatus 25 and the main element of the present invention.

In FIG. 2, the font controller 27 is a processing unit that performs processing related to the fonts operated by the CPU 7, and controls the font related graphic controller 14 (refer to FIG. 1) as well. The font controller 27, the work memory 15, the flash memory 23, and the hard disk drive 24 are connected in a readable/writable manner via the bus line 10 (refer to FIG. 1).

The flash memory 23 stores a scalable font data group SCD comprising a plurality of scalable font data related to a character or visual object. These scalable font data express the locus of a character using vectors, making it possible to display characters in any character size. The above-described scalable font data group SCD comprises a plurality of scalable font data related to preferred characters. While in the above flash memory is employed as the preferred storage medium for storing the scalable font data, the present invention is not limited thereto and, for example, the data may be stored on a hard disk drive or an external storage apparatus such as a DVD-ROM drive.

The hard disk drive 24 [more accurately, a hard disk (not shown) including the hard disk drive 24; hereinafter HDD 24] stores a plurality of pre-rasterized bitmap font data groups BMP (BMP-S, BMP-L, BMP-M, and BMP-LL) related to a character or visual object. These pre-rasterized bitmap font data are scalable font data expanded in advance into preferred sizes and formed into bitmap data, and the above-described pre-rasterized bitmap font data groups BMP respectively comprise the plurality of pre-rasterized bitmap font data related to preferred characters.

At this time, in the embodiment, the focus is placed on the fact that the number of character sizes normally used simultaneously on a single screen is limited, and thus the HDD 24 stores each of the pre-rasterized bitmap font data groups BMP-S, BMP-L, BMP-M, and BMP-LL corresponding to the character sizes of a plurality of types (here, four types). The pre-rasterized bitmap font data groups BMP-S, BMP-L, BMP-M, and BMP-LL comprise pre-rasterized bitmap font data corresponding to relatively small characters, relatively large characters, medium size characters between the sizes of BMP-S and BMP-L, and extra-large characters larger than the size of BMP-L, respectively. Then, in the embodiment, the combination of the pre-rasterized bitmap font data groups BMP-S and BMP-L (that is, the combination of the small and large character sizes), and the combination of the pre-rasterized bitmap font data groups BMP-M and BMP-L (that is, the combination of the medium and extra-large character sizes) are respectively simultaneously displayed, and the two combinations are never displayed together simultaneously.

While, in the above, a hard disk drive is employed as the preferred storage medium for storing the pre-rasterized bitmap font data, the present invention is not limited thereto and, for example, the data may be stored in flash memory or on an external storage apparatus such as a DVD-ROM drive. Further, while the character sizes are classified into four types in the above, the present invention is not limited thereto, and the characters may be classified into two or into an even larger variety of character sizes. Furthermore, rather than classification according to character size, classification according to character style, text decoration, or other predetermined condition in relation to display relevance is also possible. Further, while the number of combinations of pre-rasterized bitmap font data groups displayed simultaneously in the above is two, the present invention is not limited thereto, and a greater number is possible.

The work memory 15 is a work memory that temporarily stores the scalable font data group SCD read from the flash memory 23, the character data of the pre-rasterized bitmap font data groups BMP-S, BMP-L, BMP-M, BMP-LL, and the like, and the image information of the visual objects of maps and the like read from the HDD 24. The work memory 15 includes a scalable font area 15A for stationing the scalable font data group SCD (for copying the data read from the flash memory 23 and the like, and temporarily storing the read data in the work memory 15; hereinafter the same), and pre-rasterized bitmap font areas 15B and 15C for respectively stationing the pre-rasterized bitmap font data groups BMP-S and BMP-L (or BMP-M and BMP-LL) read from the HDD 24.

The work memory 15 is not limited to a form connected only to the graphic controller 14 as shown in FIG. 1, but may take on, for example, a form referred to as unified architecture in which the work memory 15 is provided as a predetermined area on a memory such as RAM connected to the CPU 7.

In the display processing apparatus 25 having the above-mentioned configuration, when the user starts the vehicle navigation apparatus S in this embodiment, the font controller 27 reads the scalable font data group SCD from the flash memory 23, and copies and stations the read data to the scalable font area 15A of the work memory 15, and reads the required pre-rasterized bitmap font data groups (that is, the BMP-S and BMP-L combination or the BMP-M and BMP-LL combination), and copies and stations the read groups to the pre-rasterized bitmap font areas 15B and 15C of the work memory 15. Then, for example, in a case where the character display size needs to be switched such as when the font is to be switched to a larger size to improve character readability, the font controller 27 switches the pre-rasterized bitmap font data groups stationed in the work memory 15. That is, for example, in a case where the character size is to be increased when the pre-rasterized bitmap font data group combination BMP-S and BMP-L is stationed in the work memory 15, the font controller 27 switches the data groups to the pre-rasterized bitmap font data group combination BMP-M and BMP-LL; and in a case where the character size is to be decreased when the pre-rasterized bitmap font data group combination BMP-M and BMP-LL is stationed in the work memory 15, the font controller 27 switches the data groups to the pre-rasterized bitmap font data group combination BMP-S and BMP-L.

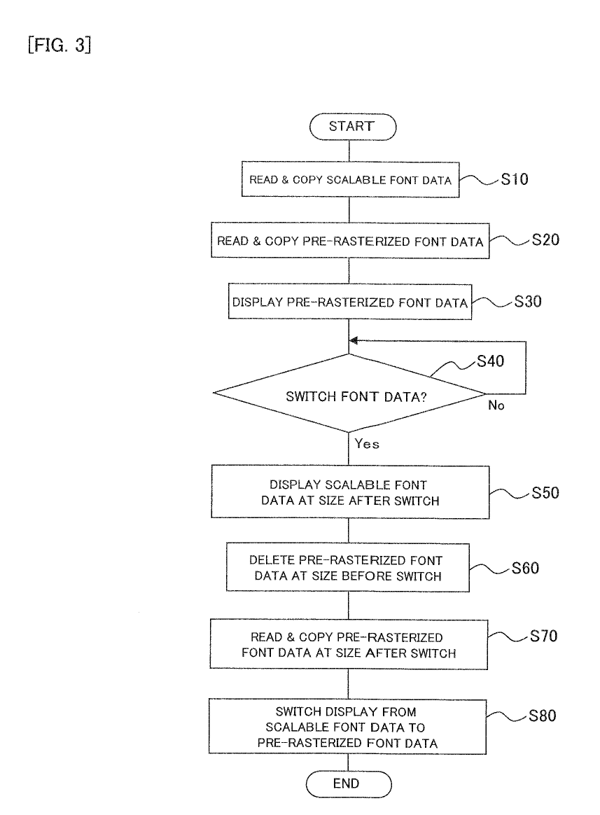

FIG. 3 is a flowchart showing the control procedure executed by the font controller 27 when such character size switching is performed. This flowchart begins when the vehicle navigation apparatus S is started.

First, in step S10, the font controller 27 reads the scalable font data group SCD from the flash memory 23, and then copies and stations the read data group SCD to the scalable font area 15A of the work memory 15

In the next step S20, the font controller 27 reads the pre-rasterized bitmap font data group combination BMP-S and BMP-L (or the BMP-M and BMP-LL combination; hereinafter the correspondence relationship within parentheses is the same), and copies and stations the read combination to the pre-rasterized bitmap font areas 15B and 15C of the work memory 15.

In the next step S30, the font controller 27 outputs image information including the required character font data from among the pre-rasterized bitmap font data groups BMP-S and BMP-L (or BMP-M and BMP-LL) read and stationed in the step S20 to the display control unit 16 via the graphic controller 14. As a result, the display is controlled by the display control unit 16 based on the outputted image information, and characters are displayed on the display 17 based on the pre-rasterized bitmap font data groups BMP-S and BMP-L (or BMP-M and BMP-LL).

In the next step S40, the font controller 27 makes a decision as to whether or not the user performed a font size switching operation using the input unit 11, in other words, whether or not the pre-rasterized bitmap font data groups stationed in the work memory 15 need to be switched. That is, as described above, in a case where the user performed a switching operation to increase the character size when the pre-rasterized bitmap font data group combination BMP-S and BMP-L is stationed in the work memory 15, the data groups need to be switched to the pre-rasterized bitmap font data group combination BMP-M and BMP-LL; and in a case where the user performed a switching operation to decrease the character size when the pre-rasterized bitmap font data group combination BMP-M and BMP-LL is stationed in the work memory 15, the data groups need to be switched to the pre-rasterized bitmap font data group combination BMP-S and BMP-L. The font controller 27 repeats this step S40 until a switching operation is performed and, when the switching operation is performed, makes the decision that the condition is satisfied and proceeds to the next step S50.

In step S50, the font controller 27 uses the scalable font data group SCD stationed in the scalable font area 15A of the work memory 15 in the step S10 so as to expand scalable fonts at the sizes after the switch, and outputs image information including the font data to the display control unit 16 via the graphic controller 14. As a result, the display is controlled by the display control unit 16 based on the outputted image information, and the character display based on the pre-rasterized bitmap font data groups BMP-S and BMP-L (or BMP-M and BMP-LL) is switched to the character display at the sizes after the switch based on the scalable font data group SCD.

In step S60, the font controller 27 deletes the pre-rasterized bitmap font data groups BMP-S and BMP-L (or BMP-M and BMP-LL) stationed in the pre-rasterized bitmap font areas 15B and 15C of the work memory 15 in the step S20. At this time, because the characters based on the scalable font data group SCD are displayed in the step S50, the above procedure does not result in termination of the display.

In step S70, the font controller 27 reads the pre-rasterized bitmap font data groups BMP-M and BMP-LL (or BMP-S and BMP-L), and copies and stations the read data groups to the pre-rasterized bitmap font areas 15B and 15C of the work memory 15.

In step S80, the font controller 27 outputs image information including the required character font data from among the pre-rasterized bitmap font data groups BMP-M and BMP-LL, (or BMP-S and BMP-L) read and stationed in the step S70 to the display control unit 16 via the graphic controller 14. As a result, the display is controlled by the display control unit 16 based on the outputted image information, and the character display at the size after the switch based on the scalable font data group SCD of the display 17 is switched to the character display at the size after the switch based on the pre-rasterized bitmap font data groups BMP-M and BMP-LL (or BMP-S and BMP-L). At this time, because the display switch is at the same size, the display on the display 17 does not change visually. With the above, the flow ends.

As described above, the display processing apparatus 25 of the embodiment creates and outputs display data for displaying a character or visual object on the display unit (in this example, the display) 17, and comprises: the temporary storage unit (in this example, the work memory) 15 that temporarily stores display data in a readable/writable manner; and the first pre-rasterized data reading processing step (in this example, the step S20 executed by the font controller 27) that extracts and reads the first font data groups (in this example, the pre-rasterized bitmap font data group) BMP-S and BMP-L (or BMP-M and BMP-LL), which satisfy the predetermined first condition in relation to the display relevance of the display unit 17, among the plurality of font data groups (in this example, the pre-rasterized bitmap font data groups) BMP-S, BMP-L, BMP-M stored in the data group storage unit (in this example, the hard disk drive) 24 and respectively comprising the plurality of pre-rasterized bitmap data related to a character or visual object, and stores the first font data groups in the pre-rasterized data areas (in this example, the pre-rasterized bitmap font areas) 15B and 15C of the temporary storage unit 15.

When the display data for displaying the a character or visual object are created, pre-rasterized bitmap data expanded into preferred sizes in advance, for example, are prepared in the data group storage unit 24 for specific font sizes having a high frequency of use, etc., thereby making it possible to execute display processing in a relatively short operation processing time period. At this time, in the embodiment, the first pre-rasterized data reading processing unit S20 extracts and reads each time only the first font data groups BMP-S and BMP-L (or BMP-M, BMP-LL), which satisfies a predetermined first condition in relation to the display relevance of the display unit 24, among the plurality of the font data groups BMP-S, BMP-L, BMP-M, BMP-LL stored in advance in the data group storage unit 24, and expands and stores the read groups in the temporary storage unit 15. With this arrangement, the memory capacity required in the temporary storage unit 15 is an amount appropriate for only the data amount extracted and read, making it possible to significantly reduce the amount of memory consumed compared to a case where the plurality of font data groups of the data group storage unit 24 is all read and temporarily stored in the temporary storage unit 15.

As described above, only a portion of the font data groups is extracted from the data group storage unit 24 upon consideration of display relevance and expanded and stored in the temporary storage unit 15, thereby making it possible to minimally secure the font size data required for actual display on the display unit 17 and decrease the amount of memory consumed.

As described above, the display processing method of the embodiment is a method for creating and outputting display data for displaying a character or visual object on the display unit 17, wherein: among the plurality of font data groups BMP-S, BMP-L, BMP-M, and BMP-LL stored in the data group storage unit 24 and respectively comprising the plurality of pre-rasterized bitmap data related to a character or visual object, the first font data groups BMP-S and BMP-L (or BMP-M and BMP-LL) that satisfy the predetermined first condition in relation to the display relevance of the display unit 17 are extracted and read from the data group storage unit 24, and stored in the pre-rasterized data areas 15B and 15C of the temporary storage unit 15 in a readable/writable manner.

In the embodiment, among the plurality of the font data groups BMP-S, BMP-L, BMP-M, and BMP-LL stored in advance in the data group storage unit 24, only the first font data groups BMP-S and BMP-L (or BMP-M and BMP-LL) that satisfy the predetermined first condition in relation to the display relevance are extracted, read, expanded, and stored in the temporary storage unit 15 on a case-by-case basis. With this arrangement, the amount of memory required in the temporary storage unit 15 is an amount appropriate for only the data amount extracted and read, making it possible to significantly reduce the amount of memory consumed compared to a case where the plurality of font data groups of the data group storage unit 24 is all read and temporarily stored in the temporary storage unit 15.

As described above, only a portion of the font data groups is extracted from the data group storage unit 24 upon consideration of display relevance and expanded and stored in the temporary storage unit 15, thereby making it possible to minimally secure the font size data required for actual display on the display unit 17 and decrease the amount of memory consumed.

As described above, in the display processing program of the embodiment, a procedure wherein, among the plurality of font data groups BMP-S, BMP-L, BMP-M, and BMP-LL stored in the data group storage unit 24 and respectively comprising the plurality of pre-rasterized bitmap data related to a character or visual object, the first font data groups BMP-S and BMP-L (or BMP-M and BMP-LL) that satisfy the predetermined first condition in relation to the display relevance of the display unit 17 are extracted and read from the data group storage unit 24, and stored in the pre-rasterized data areas 15B and 15C of the temporary storage unit 15 is executed in the operation unit (in this example, the CPU) 7 provided in the display processing apparatus 25.

In the embodiment, among the plurality of the font data groups BMP-S, BMP-L, BMP-M, and BMP-LL stored in advance in the data group storage unit 24, only the first font data groups BMP-S and BMP-L (or BMP-M and BMP-LL) that satisfy the predetermined first condition in relation to the display relevance are extracted, read, expanded, and stored in the temporary storage unit 15 on a case-by-case basis. With this arrangement, the amount of memory required in the temporary storage unit 15 is an amount appropriate for only the data amount extracted and read, making it possible to significantly reduce the amount of memory consumed compared to a case where the plurality of font data groups of the data group storage unit 24 is all read and temporarily stored in the temporary storage unit 15.

As described above, only a portion of the font data groups is extracted from the data group storage unit 24 upon consideration of display relevance and expanded and stored in the temporary storage unit 15, thereby making it possible to minimally secure the font size data required for actual display on the display unit 17 and decrease the amount of memory consumed.

In the display processing apparatus of the above embodiment, the first pre-rasterized data reading processing unit S20 reads the first font data groups used substantially simultaneously by the display unit as the first condition.

With only a portion of the font data groups, that is, only the font data groups used substantially simultaneously by the display unit 17, extracted from the data group storage unit 24 and expanded and stored in the temporary storage unit 15, the font size data required for actual display on the display unit 17 are minimally secured, making it possible to decrease the amount of memory consumed.

The display processing apparatus 25 of the above embodiment further comprises the deletion processing step (in this example, the step S60 executed by the font controller 27) that deletes the first font data groups BMP-S and BMP-L (or BMP-M and BMP-LL) stored in the pre-rasterized data areas 15B and 15C in accordance with the switch instruction signal (in this example, the step S40 executed by the font controller 27) that switches the first font data groups BMP-S and BMP-L (or BMP-M and BMP-LL); and the second pre-rasterized data reading processing step (in this example, the step S70 executed by the font controller 27) that extracts and reads the second font data groups [in this example, the pre-rasterized bitmap font data groups BMP-M and BMP-LL (or BMP-S and BMP-L)] that satisfy the predetermined second condition corresponding to the switch instruction signal S40 in relation to the display relevance of the display step 17, and stores the read data groups in the pre-rasterized data areas 15B and 15C.

When the switch instruction signal S40 for switching the display scene and display form is issued after the first font data groups BMP-S and BMP-L (or BMP-M and BMP-LL) corresponding to the first condition are expanded in the pre-rasterized data areas 15B and 15C of the temporary storage unit 15, the first font data groups BMP-S and BMP-L (or BMP-M and BMP-LL) of the pre-rasterized data areas 15B and 15C are deleted in the deletion processing step S60. Subsequently, the second pre-rasterized data reading processing step S70 extracts and reads from the data group storage unit 24 the second font data groups BMP-M and BMP-LL (or BMP-S and BMP-L) corresponding to the second condition, in accordance with the switch instruction signal S40, and expands and stores the read data groups in the pre-rasterized data areas 15B and 15C. In this manner, the font data groups are expanded and stored in the temporary storage unit 15 while being switched, thereby making it possible to smoothly execute corresponding displays using the minimum amount of memory required.

In the display processing method of the above embodiment, the first font data groups BMP-S and BMP-L (or BMP-M and BMP-LL) stored in the pre-rasterized data areas 15B and 15C are deleted in accordance with the switch instruction signal S40 that switches the first font data groups BMP-S and BMP-L (or BMP-M and BMP-LL) and, after deletion, the second font data groups BMP-M and BMP-LL (or BMP-S and BMP-L) that satisfy the predetermined second condition in relation to the display relevance of the display unit 17 are extracted and read from the data group storage unit 24 and stored in the pre-rasterized data areas 15B and 15C.

After the first font data groups BMP-S and BMP-L (or BMP-M and BMP-LL) corresponding to the first condition are expanded in the pre-rasterized data areas 15B and 15C of the temporary storage unit 15 and the corresponding display is executed, the first font data groups BMP-S and BMP-L (or BMP-M and BMP-LL) of the pre-rasterized data areas 15B and 15C are deleted when the display scene or display form is switched. Subsequently, the second font data groups BMP-M and BMP-LL (or BMP-S and BMP-L) corresponding to the separate second condition are extracted and read from the data group storage unit 24, and expanded and stored in the pre-rasterized data areas 15B and 15C. In this manner, the font data groups are expanded and stored in the temporary storage unit 15 while being switched, thereby making it possible to smoothly execute corresponding displays using the minimum amount of memory required.

In the display processing apparatus 25 of the above embodiment, the second pre-rasterized data reading processing unit reads the second font data groups used substantially simultaneously by the display unit as the second condition.

After the deletion processing step S60 deletes the first font data groups BMP-S and BMP-L (or BLP-M and BMP-LL) in accordance with the switch instruction signal S40, another portion of the font data groups, that is the font data groups used substantially simultaneously by the display unit, are expanded and stored in the temporary storage unit 15 while being switched, thereby making it possible to smoothly execute the corresponding display using the minimum amount of memory required.

The display processing apparatus 25 of the above embodiment further comprises the scalable data reading processing step (in this example, the step S10 executed by the font controller 27) that extracts and reads the third font data group (in this example, the scalable font data group) SCD stored in the scalable data storage unit (in this example, the flash memory) 23 and comprising the plurality of scalable font data related to a character or visual object, and stores the read data group in the scalable data area (in this example, the scalable font area) 15A of the temporary storage unit 15; and the scalable display switching step (in this example, the step S50 executed by the font controller 27) that outputs to the display unit 17 the display data corresponding to the switch instruction signal S40 using the third font data group SCD stored in the scalable data area 15A during the period after the first font data groups BMP-S and BMP-L (or BMP-M and BMP-LL) are deleted from the pre-rasterized data areas 15B and 15C and until the second font data groups BMP-M and BMP-LL (or BMP-S and BMP-L) are stored in the pre-rasterized data areas 15B and 15C.

The third font data group SCD that is based on scalable font data capable of reducing or enlarging characters and visual objects to any size is prepared in the scalable data storage unit 23, and expanded and stored in the scalable data area 15A of the temporary storage unit 15 by the scalable data reading processing step S10. Then, during the period after the first font data groups BMP-S and BMP-L (or BMP-M and BMP-LL) are deleted from the pre-rasterized data areas 15B and 15C and until the second font data groups BMP-M and BMP-LL (or BMP-S and BMP-L) are stored in the pre-rasterized data areas 15B and 15C, the scalable display switching step S50 outputs the display data corresponding to the switch instruction signal S40 to the display unit 17 using the third font data group SCD, making it possible to fill in the blank area that exists while the first font data groups BMP-S and BMP-L (or BMP-M and BMP-LL) are being switched to the second font data groups BMP-M and BMP-LL (or BMP-S and BMP-L) and display the scalable font data, thereby avoiding a state where nothing is displayed during data switching.

In the display processing method of the above embodiment, the third font data group SCD stored in the scalable data storage unit 23 and comprising the plurality of scalable font data related to a character or visual object is extracted, read, and stored in the scalable data area 15A of the temporary storage unit 15 and, during the period after the first font data groups BMP-S and BMP-L (or BMP-M and BMP-LL) are deleted from the pre-rasterized data areas 15B and 15C and until the second font data groups BMP-M and BMP-LL (or BMP-S and BMP-L) are stored in the pre-rasterized data areas 15B and 15C, the display data corresponding to the switch instruction signal S40 are outputted to the display unit 17 using the third font data group SCD stored in the scalable data area 15A.

The third font data group SCD that is based on scalable font data capable of reducing or enlarging characters and visual objects to any size is prepared in the scalable data storage unit 23, and expanded and stored in the scalable data area 15A of the temporary storage unit 15. Then, during the period after the first font data groups BMP-S and BMP-L (or BMP-M and BMP-LL) are deleted from the pre-rasterized data areas 15B and 15C and until the second font data groups BMP-M and BMP-LL (or BMP-S and BMP-L) are stored in the pre-rasterized data areas 15B and 15C, the display data corresponding to the switch instruction signal S40 are outputted to the display unit 17 using the third font data group SCD, making it possible to fill in the blank area that exists while the first font data groups BMP-S and BMP-L (or BMP-M and BMP-LL) are being switched to the second font data groups BMP-M and BMP-LL (or BMP-S and BMP-L) and display the scalable font data, thereby avoiding a state where nothing is displayed during data switching.

The display processing apparatus 25 of the above embodiment further comprises the pre-rasterized display switching step (in this example, the step S80 executed by the font controller 27) that outputs to the display unit 17 display data employing the second font data groups BMP-M and BMP-LL (or BMP-S and BMP-L) stored in the pre-rasterized data areas 15B and 15C, in place of the third font data group SCD.

When storage of the second font data groups BMP-M and BMP-LL (or BMP-S and BMP-L) in the pre-rasterized data areas 15B and 15C of the temporary storage unit 15 is completed, the pre-rasterized display switching step S80 outputs the display data employing the second font data groups BMP-M and BMP-LL (or BMP-S and BMP-L) to the display unit 17 in place of the third font data group SCD. With this arrangement, the switching of the pre-rasterized data executed by the deletion processing step S60 and the second pre-rasterized data reading processing step S70 is smoothly completed.

In the display processing method of the above embodiment, the second font data groups BMP-M and BMP-LL (or BMP-S and BMP-L) stored in the pre-rasterized data areas 15B and 15C are outputted to the display unit 17 in place of the third font data group SCD.

When storage of the second font data groups BMP-M and BMP-LL (or BMP-S and BMP-L) in the pre-rasterized data areas 15B and 15C of the temporary storage unit 15 is completed, the display data employing the second font data groups BMP-M and BMP-LL (or BMP-S and BMP-L) are outputted to the display unit 17 in place of the third font data group SCD. With this arrangement, the two switching processes of the pre-rasterized data are smoothly completed.

The display processing apparatus 25 of the above embodiment further comprises the scalable data reading processing step S10 that extracts and reads the third font data group SCD stored in the scalable data storage unit 23 and comprising the plurality of scalable font data related to a character or visual object, and stores the read group in the scalable data area 15A of the temporary storage unit 15; and the scalable display switching step S50 that outputs the display data corresponding to the switch instruction signal S40 that switches the first font data groups BMP-S and BMP-L (or BMP-M and BMP-LL) to the display unit 17 using the third font data group SCD stored in the scalable data area 15A in accordance with the switch instruction signal S40.

In the embodiment, the scalable data reading processing step S10 extracts and reads the third font data group SCD stored in the scalable data storage unit 23 and comprising the plurality of scalable font data related to a character or visual object, and stores the read group in the scalable data area 15A of the temporary storage unit 15. Then, the scalable display switching step S50 outputs the display data corresponding to the switch instruction signal S40 that switches the first font data groups BMP-S and BMP-L (or BMP-M and BMP-LL) to the display unit 17 using the third font data group SCD stored in the scalable data area 15A in accordance with the switch instruction signal S40, making it possible to fill in the blank area that exists during pre-rasterized data switching and execute a display, thereby avoiding a state where nothing is displayed during the above data switching.

In the display processing method of the above embodiment, the third font data group SCD stored in the scalable data storage unit 23 and comprising the plurality of scalable font data related to a character or visual object is extracted, read, and stored in the scalable data area 15A of the temporary storage unit 15, and the display data corresponding to the switch instruction signal S40 that switches the first font data groups BMP-S and BMP-L (or BMP-M and BMP-LL) are outputted to the display unit 17 using the third font data group SCD stored in the scalable data area 15A in accordance with the switch instruction signal S40.

In the embodiment, the third font data group SCD stored in the scalable data storage unit 23 and comprising the plurality of scalable font data related to a character or visual object is extracted, read, and stored in the scalable data area 15A of the temporary storage unit 15. Then, the display data corresponding to the switch instruction signal S40 that switches the first font data groups BMP-S and BMP-L (or BMP-M and BMP-LL) are outputted to the display unit 17 using the third font data group SCD stored in the scalable data area 15A in accordance with the switch instruction signal S40, making it possible to fill in the blank area that exists during the two switching processes of the pre-rasterized data and execute a display, thereby avoiding a state where nothing is displayed during the above data switching.

Furthermore, while the foregoing embodiment has been described in connection with an illustrative scenario in which the present invention is applied to a vehicle navigation apparatus configured to provide vehicle route guidance, the present invention is not limited thereto and may be applied to various apparatus associated with the display processing of a character or visual object, such as a cellular phone, a printer, a PC (Personal Computer), or a PDA (Personal Digital Assistance), which is a portable terminal.

The display processing apparatus 25 of the above embodiment creates and outputs display data for display a character or visual object on the display 17, and comprises: the work memory 15 that temporarily stores display data in a readable/writable manner; and the font controller 27 (specifically, the step S20 executed by the font controller 27) that extracts and reads among the plurality of pre-rasterized bitmap font data groups BMP-S, BMP-L, BMP-M, and BMP-LL stored on the hard disk drive 24 and respectively comprising the plurality of pre-rasterized bitmap data related to a character or visual object the pre-rasterized bitmap font data groups BMP-S and BMP-L (or BMP-M and BMP-LL) that satisfy the predetermined first condition in relation to the display relevance of the display 17, and stores the read groups in the pre-rasterized bitmap font areas 15B and 15C of the work memory 15.

When the display data for displaying the a character or visual object are created, pre-rasterized bitmap data expanded into preferred sizes in advance, for example, are prepared in the hard disk drive 24 for specific font sizes having a high frequency of use, etc., thereby making it possible to execute display processing in a relatively short operation processing time period. At this time, in the embodiment, the font controller 27, on a case-by-case basis, extracts and reads among the plurality of pre-rasterized bitmap font data groups BMP-S, BMP-L, BMP-M, and BMP-LL stored in advance on the hard disk drive 24 only the pre-rasterized bitmap font data groups BMP-S and BMP-L (or BMP-M and BMP-LL) that satisfy the predetermined first condition in relation to the display relevance, and expands and stores the read groups in the work memory 15. With this arrangement, the amount of memory required in the work memory 15 is an amount appropriate for only the data amount extracted and read, making it possible to significantly reduce the amount of memory consumed compared to a case where the plurality of font data groups of the hard disk drive 24 is all read and temporarily stored in the work memory 15.

As described above, only a portion of the font data groups is extracted from the hard disk drive 24 upon consideration of display relevance and expanded and stored in the work memory 15, thereby making it possible to minimally secure the font size data required for actual display on the display 17 and reduce the amount of memory consumed.

The display processing method of the above embodiment is a method for creating and outputting display data for displaying a character or visual object on the display 17, wherein: among the plurality of pre-rasterized bitmap font data groups BMP-S, BMP-L, BMP-M, and BMP-LL stored on the hard disk drive 24 and respectively comprising the plurality of pre-rasterized bitmap data related to a character or visual object, the pre-rasterized bitmap font data groups BMP-S and BMP-L (or BMP-M and BMP-LL) that satisfy the predetermined first condition in relation to the display relevance of the display 17 are extracted and read from the hard disk drive 24, and stored in the pre-rasterized bitmap font data areas 15B and 15C of the work memory 15.

In the embodiment, among the plurality of the pre-rasterized bitmap font data groups BMP-S, BMP-L, BMP-M, and BMP-LL stored in advance on the hard disk drive 24, only the pre-rasterized bitmap font data groups BMP-S and BMP-L (or BMP-M and BMP-LL) that satisfy the predetermined first condition in relation to the display relevance are extracted, read, expanded, and stored in the work memory 15 on a case-by-case basis. With this arrangement, the amount of memory required in the work memory 15 is an amount appropriate for only the data amount extracted and read, making it possible to significantly reduce the amount of memory consumed compared to a case where the plurality of font data groups of the hard disk drive 24 is all read and temporarily stored in the work memory 15.

As described above, only a portion of the font data groups is extracted from the hard disk drive 24 upon consideration of display relevance and expanded and stored in the work memory 15, thereby making it possible to minimally secure the font size data required for actual display on the display 17 and reduce the amount of memory consumed.

1. A display processing apparatus that creates and outputs display data for displaying a character or visual object on a display unit, comprising:
a temporary storage unit that temporarily stores said display data in a readable/writable manner; and
a first pre-rasterized data reading processing unit that extracts and reads a first font data group, which satisfies a predetermined first condition in relation to the display relevance of said display unit, among a plurality of font data groups stored in a data group storage unit and respectively comprising a plurality of pre-rasterized bitmap data related to a character or visual object, and stores said first font data group in a pre-rasterized data area of said temporary storage unit.

2. The display processing apparatus according to claim 1, wherein:
said first pre-rasterized data reading processing unit reads said first font data group to be used substantially simultaneously by said display unit as said first condition.

3. The display processing apparatus according to claim 1, further comprising:
a deletion processing unit that deletes said first font data group stored in said pre-rasterized data area in accordance with a switch instruction signal that switches said first font data group; and
a second pre-rasterized data reading processing unit that extracts and reads a second font data group that satisfies a predetermined second condition corresponding to said switch instruction signal in relation to the display relevance of said display unit, and stores said second font data group in said pre-rasterized data area.

4. The display processing apparatus according to claim 3, wherein:
said second pre-rasterized data reading processing unit reads said second font data group to be used substantially simultaneously by said display unit as said second condition.

5. The display processing apparatus according to claim 3, further comprising:
a scalable data reading processing unit that extracts and reads a third font data group stored in a scalable data storage unit and comprising a plurality of scalable font data related to a character or visual object, and stores said third font data group in a scalable data area of said temporary storage unit; and
a scalable display switching unit that outputs said display data corresponding to said switch instruction signal to said display unit using said third font data group stored in said scalable data area during the period after said first font data group is deleted from said pre-rasterized data area until said second font data group is stored in said pre-rasterized data area.

6. The display processing apparatus according to claim 5, further comprising:
a pre-rasterized display switching unit that outputs to said display unit said display data employing said second font data group stored in said pre-rasterized data area, in place of said third font data group.

7. The display processing apparatus according to claim 1, further comprising:
a scalable data reading processing unit that extracts and reads a third font data group stored in a scalable data storage unit and comprising a plurality of scalable font data related to a character or visual object, and stores said third font data group in a scalable data area of said temporary storage unit; and
a scalable display switching unit that, in accordance with a switch instruction signal that switches said first font data group, outputs said display data corresponding to said switch instruction signal to said display unit using said third font data group stored in said scalable data area.

8. A display processing method for creating and outputting display data for displaying a character or visual object on a display device, wherein:
among a plurality of font data groups stored in a data group storage unit and respectively comprising a plurality of pre-rasterized bitmap data related to a character or visual object, a first font data group that satisfies a predetermined first condition in relation to the display relevance of said display unit is extracted, read, and stored in a pre-rasterized data area of a temporary storage unit.

9. The display processing method according to claim 8, wherein:
said first font data group stored in said pre-rasterized data area is deleted in accordance with a switch instruction signal that switches said first font data group; and
after the deletion, a second font data group that satisfies a predetermined second condition in relation to the display relevance of said display unit is extracted and read from said data group storage unit, and stored in said pre-rasterized data area.

10. The display processing method according to claim 9, wherein:
a third font data group stored in a scalable data storage unit and comprising a plurality of scalable font data related to a character or visual object is extracted, read, and stored in a scalable data area of said temporary storage unit; and
said display data corresponding to said switch instruction signal are outputted to said display unit using said third font data group stored in said scalable data area during the period after said first font data group is deleted from said pre-rasterized data area until said second font data group is stored in said pre-rasterized data area.

11. The display processing method according to claim 10, wherein:
said display data employing said second font data group stored in said pre-rasterized data area are outputted to said display unit in place of said third font data group.

12. The display processing method according to claim 8, wherein:
a third font data group stored in a scalable data storage unit and comprising a plurality of scalable font data related to a character or visual object is extracted, read, and stored in a scalable data area of said temporary storage unit; and
said display data corresponding to a switch instruction signal that switches said first font data group are outputted to said display unit using said third font data group stored in said scalable data area in accordance with said switch instruction signal.

13. A display processing program for executing, in an operation unit provided in a display processing apparatus, a procedure wherein:
among a plurality of font data groups stored in a data group storage unit and respectively comprising a plurality of pre-rasterized bitmap data related to a character or visual object, a first font data group that satisfies a predetermined first condition in relation to the display relevance of said display unit is extracted, read, and stored in a pre-rasterized data area of a temporary storage unit.
